(19) United States
(12) Patent Application Publication
(10) Pub. No.: US 2013/0145838 A1
(43) Pub. Date: Jun. 13, 2013

(54) ENCAPSULATED DOWNHOLE SENSOR AND METHOD OF APPLYING A METALLIC LAYER TO A DOWNHOLE SENSOR

(71) Applicant: Jonathan Hook, Houston, TX (US)

(72) Inventor: Jonathan Hook, Houston, TX (US)

(73) Assignee: BAKER HUGHES INCORPORATED, Houston, TX (US)

(21) Appl. No.: 13/324,471

(22) Filed: Dec. 13, 2011

(51) Int. Cl. E21B 47/00; B05D 5/12

(52) U.S. Cl. 73/152.51; 73/152.54; 427/123; 427/125; 427/124

(57) ABSTRACT

A downhole sensor to detect characteristics in a borehole comprises at least one sensing unit to sense a characteristic in the borehole and a metallic layer covering at least a portion of the sensing unit exposed to an interior of the borehole.

### BACKGROUND

Sensors are placed in bore holes to measure characteristics in the borehole, such as pressure, drag, torque, or composition of a borehole fluid or borehole formation. However, over time, fluids in the borehole penetrate polymers that make up or encase the sensors, degrading performance of sensors.

### SUMMARY

According to one aspect of the disclosed invention, a downhole sensor to detect characteristics in a borehole comprises at least one sensing unit to sense at least one characteristic in the borehole; and at least one metallic layer covering at least a portion of the at least one sensing unit exposed to an interior of the borehole.

According to another aspect of the disclosed invention, a downhole analysis assembly comprises an analysis assembly casing to be inserted downhole in a borehole; and at least one sensing unit connected to the analysis assembly casing to sense at least one characteristic in the borehole, at least a portion of the at least one sensing unit exposed to an interior of the borehole outside the analysis assembly casing being coated with a metallic layer.

According to yet another aspect of the disclosed invention, a method of applying a metallic layer to a downhole sensor comprises coating at least a portion of a downhole sensor to sense characteristics from an interior of a borehole with a metallic layer to form a hermetic seal between the downhole sensor and the interior of the borehole.

### BRIEF DESCRIPTION OF THE DRAWINGS

Referring now to the drawings wherein like elements are numbered alike in the several Figures:

FIG. 1 illustrates an embodiment of a borehole rig structure;

FIG. 2 illustrates an analysis assembly according to one embodiment;

FIGS. 3A and 3B illustrate detection units according to two embodiments;

FIG. 4 is a plan view of a sensing unit according to one embodiment;

FIG. 5 is a block diagram of a sensing unit according to one embodiment;

FIG. 6 is a block diagram of the analysis assembly according to one embodiment; and

FIGS. 7A and 7B illustrate an exemplary method of applying a metal coating layer to a sensing unit according to one embodiment.

### DETAILED DESCRIPTION

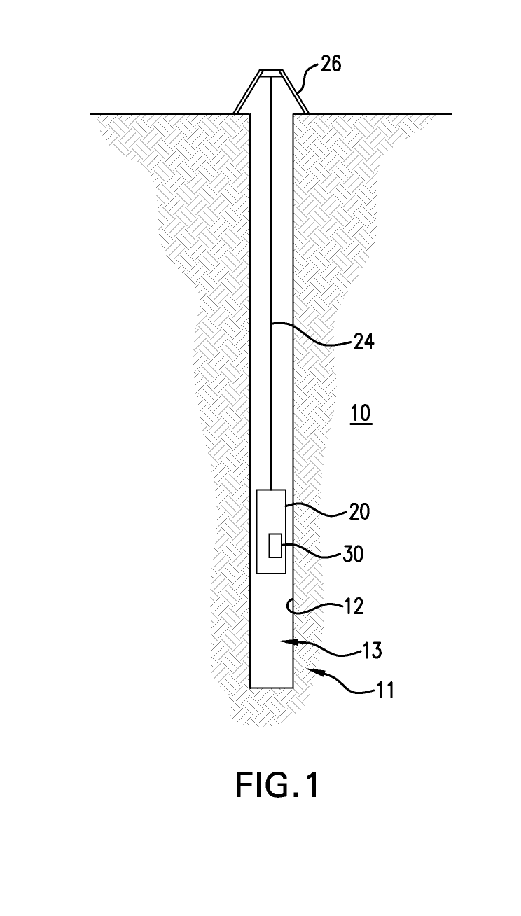

FIG. 1 illustrates a borehole rig assembly according to one embodiment. The borehole rig assembly includes a support structure 26, a cable 24, and an analysis assembly 20 connected to the end of the drill pipe or cable 24. The analysis assembly 20 is inserted into the borehole 11. Geological matter is removed from the geological formation 10 to form a borehole wall 12, and a space defined by the borehole wall 12 is the borehole interior 13. During a drilling operation and analysis operation, the borehole interior 13 may be filled with fluids such as chemicals, hydrocarbons, and water, as well as solids such as clay, particles from the geological formation 10, and drilling mud cake.

An embodiment of the analysis assembly 20 includes a sensing unit 30 to sense a characteristic in the borehole 11, such as borehole pressure, density, composition of fluid in the borehole, composition of the formation 10, or any other characteristic. According to some embodiments, the analysis assembly 20 is disposed with a drill string, e.g., connected to a drill bit, and the analysis assembly measures drag, torque, or other characteristics. In an alternative embodiment, the analysis assembly 20 is inserted into the borehole 11 after a drill bit is removed from the borehole 11, for example via a wireline or wired pipe. The analysis assembly, in some embodiments, is disposed with a drill string as part of a logging-while-drilling (LWD) application.

In one embodiment, the analysis assembly 20 is supported by the cable 24 and transmits data to the outside surface of the geological formation 10 via the cable 24. According to alternative embodiments, the analysis assembly is supported and moved in the borehole 11 by rigid structures, such as piping, either in addition to, or instead of, the cable 24.

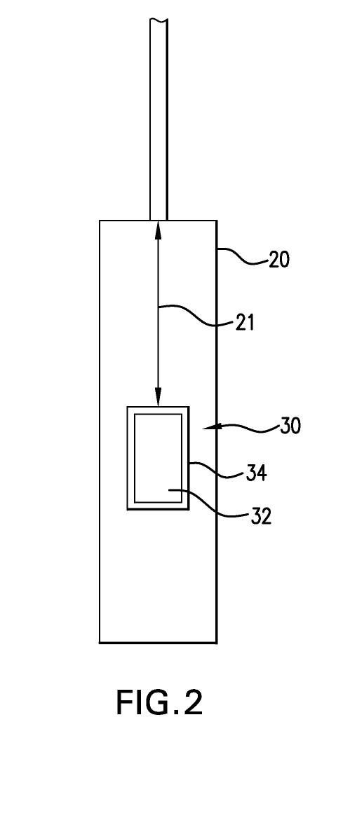

FIG. 2 illustrates the analysis assembly 20 according to one embodiment. The analysis assembly 20 includes the sensing unit 30 and a wire 21 that transmits data to the cable 24 and receives power from the cable 24. The sensing unit 30 includes a casing 32 and a metallic coating 34 that encapsulates the sensing unit 30. According to one embodiment, the casing 32 includes a polymer, such as plastic, epoxy, or any other rigid material capable of withstanding extreme temperatures and pressures of a borehole. For example, the casing 32 may include an APTIV film covering, and the metallic coating 34 may be applied to the APTIV film. The metallic coating 34 acts as a hermetic barrier to isolate and protect the sensing unit 30 from fluids, such as water, chemicals, or other materials in the borehole 11.

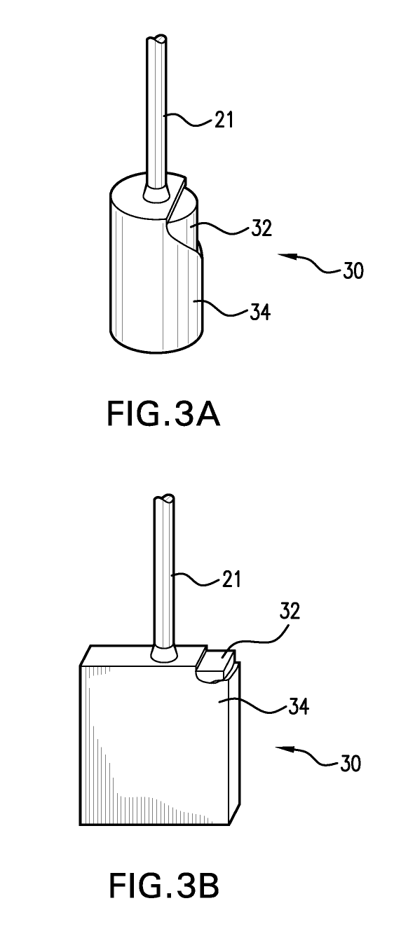

FIGS. 3A and 3B illustrate sensing units 30 according to exemplary embodiments. In FIGS. 3A and 3B, a portion of the metallic coating 34 is shown as being cut away for illustration purposes only. A sensing unit 30 may have any external shape and any internal configuration. For example, FIG. 3A illustrates a sensing unit 30 having a substantially cylindrical shape. The sensing unit 30 includes a casing 32 that is encased in a metallic coating 34. A wire 21 extends from one end of the sensing unit 30 to transmit data and receive power from an external source. FIG. 3B illustrates a substantially rectangular sensing unit 30. The sensing unit may include various components such as a sensor and downhole electronics (e.g., circuits, processor chips, etc.), and one or more of these components may be coated with or otherwise encased in the polymer and/or metallic coating. In some embodiments, the polymer and/or metallic coating is directly deposited on or otherwise coats at least some portions of the components.

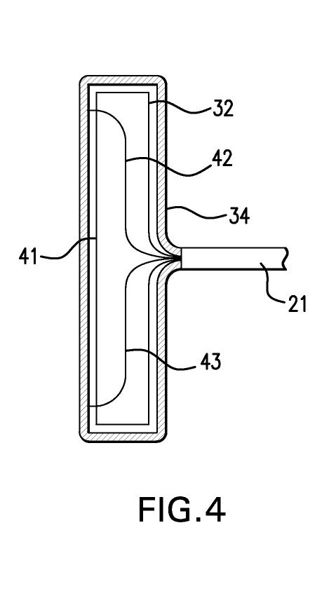

FIG. 4 illustrates one example of a sensing unit 30. In FIG. 4, the sensing unit 30 is a piezo-electric pressure sensor that receives pressure on a sensing surface 41 and generates a voltage at the leads 42 and 43. The voltage is transmitted to the wire 21 which is connected to circuitry to amplify and/or analyze the voltage to determine a pressure sensed by the sensing surface 41.

The sensing surface 41 and leads 42 and 43 are mounted to or in a casing 32. According to one embodiment, the casing includes a polymer material. The casing 32 and the sensing surface 41 are encapsulated in the metallic layer 34 which acts as a hermetic seal to prevent water and other chemicals from contacting the casing 32 or sensing surface 41. According to one embodiment, the entire sensing unit 30, including the sensing surface 41 and casing 32, is encapsulated in the metallic layer 34. However, in other embodiments, portions of the casing 32 or other portions of the sensing unit 30 are made of metal, and the portions that are made of metal may not be encased in the metallic layer 34. In one embodiment, only portions of the sensing unit 30 exposed to an interior 13 of the borehole 11 are coated with the metallic layer 34. For example, only the sensing surface 41 and the portions of the casing on the same side as the sensing surface 41 may be coated with the metallic layer 34.

Although FIG. 4 illustrates one type of sensor, any type of sensor provided downhole in a borehole 11 may be encapsulated in a metallic layer 34 according to embodiments of the present invention. In particular, the metallic layer 34 provides a hermetic seal against chemicals, water, and other fluids that may otherwise damage the sensor, and any sensor exposed to the chemicals, water, and other fluids may be protected by the metallic layer 34. Some exemplary sensors include pressure sensors, orientation sensors, radiation sensors, drag sensors, accelerometers, and torque sensors. However, the present invention is not limited to the above-listed sensors.

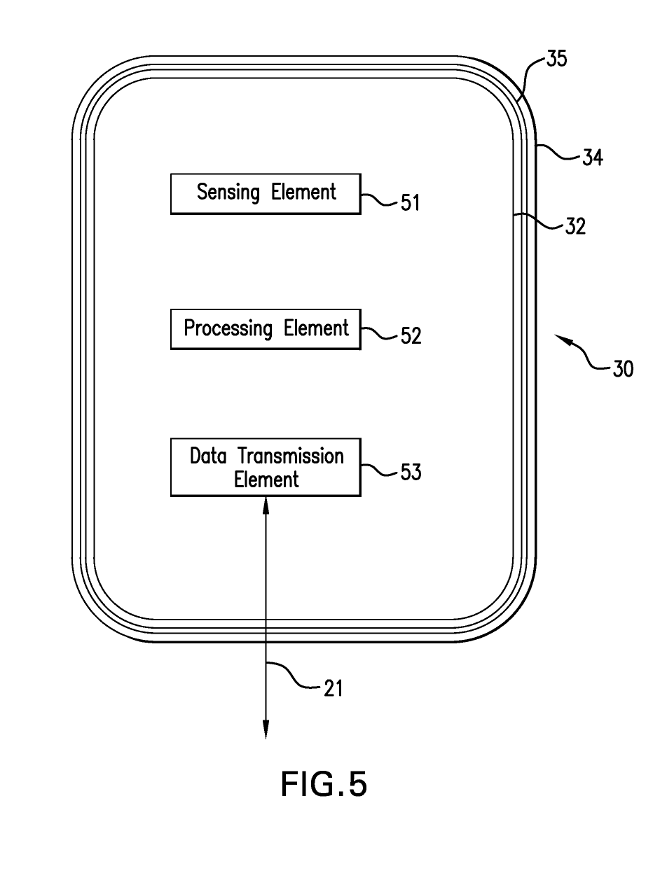

FIG. 5 illustrates a block diagram of a sensing unit 30 according to one embodiment. The sensing unit 30 includes a casing 32, a metallic layer 34 encapsulating the casing 32, and a polymer layer 35 located between the metallic layer 34 and the casing 32. In one embodiment, the polymer layer 35 encapsulates the casing 32. For example, the casing may include a polymer film covering and the metallic coating 34 may be applied to the polymer film. Within the casing 32 is a sensing element 51, such as a pressure sensor, radiation sensor, or other sensor. A processing element 52 receives sensing data from the sensing element 51 and processes the sensing data, such as by converting an analog signal to a digital signal, comparing the sensed data to other data, or performing any other desired processing functions. A data transmission element 53 transmits the data from the processing element 52 to a wire 21 to be transmitted to an external device, such as a computer to analyze the sensed data to provide information about the borehole 11 to a user or system. The data transmission element 53 may be a wireless transmission device, such as an antenna, or a wired transmission device, such as a wired port.

In the embodiment of FIG. 5, the processing element 52 and data transmission element 53 are encapsulated in the casing 32 and the metallic layer 34. However, in other embodiments, the processing element 52 and data transmission element 53 are not encapsulated in the casing 32 and the metallic layer 34. For example, in some embodiments, only the sensors or other components of the sensing unit 30 that are exposed to water, chemicals or other borehole conditions outside a casing of the analysis assembly 20 are encapsulated in the metallic layer 34.

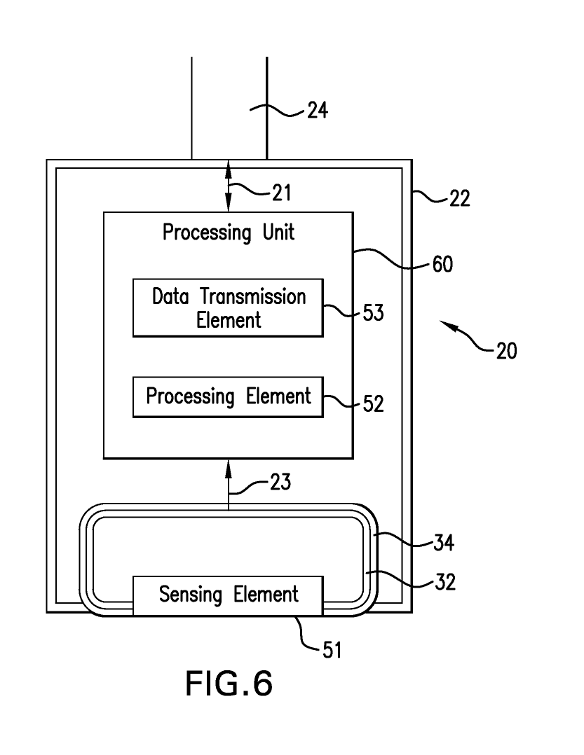

FIG. 6 illustrates an analysis assembly 20 in which a sensing unit 30 exposed to an outside of the analysis assembly 20 is encapsulated in a metallic layer 34. The analysis assembly 20 includes a sensing unit 30 and a processing unit 60. The sensing unit 30 includes a casing 32, a sensing element 51 exposed to an outer surface of the casing 32, and a metallic layer 34 encapsulating the sensing element 51 and/or the casing 32. The surface of the sensing unit 30 including the sensing element 51 is outside a casing 22 of the analysis assembly 20 to allow the sensing element 51 to sense a characteristic of the borehole 11. According to alternative embodiments, all of the sensing unit 30 is located outside a casing 22 of the analysis assembly 20, or a portion of the sensing unit 30 greater than just the sensing element 51 is located outside the casing 22 of the analysis assembly 20.

A wire 23 connects the sensing unit 30 to a processing unit 60. The processing unit 60 includes a processing element 52 and a transmission element 53, as discussed above with respect to FIG. 5. The processing unit 60 is located entirely within the casing 22 of the analysis assembly 20, and the processing unit 60 is not encapsulated in a metallic layer 34. According to some embodiments, the casing 22 of the analysis assembly 20 is metal and forms a hermetic seal to prevent water, chemicals, or other fluids in the borehole 11 from entering the casing 22. In some embodiments, both the sensing unit 30 and the processing unit 60 are encapsulated in a metallic layer 34. In yet other embodiments, each separately encased module in an analysis assembly is encapsulated by a separate metallic layer 34.

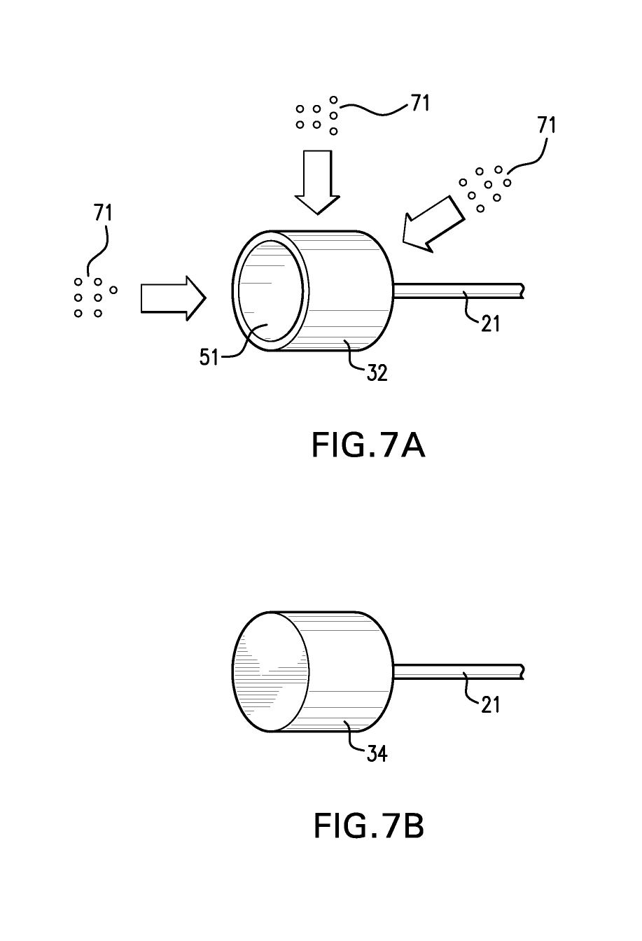

FIGS. 7A and 7B illustrate a process of applying a metallic layer 34 to a sensing unit 30. In FIG. 7A, metallic atoms or molecules 71 are applied to the casing 32, the sensing element 51 and/or other components of the sensing unit 30 to form the metallic layer 34, as illustrated in FIG. 7B. The metallic atoms or molecules are applied by any metal additive process, including vacuum deposition, sputtering, electroless deposition, or any other metal additive process. Example metallic atoms or molecules applied to the sensing unit 30 include aluminum, copper, gold, iridium, platinum, and titanium or combination as an alloyed metal. In one embodiment, the process includes encasing one or more of the components (or desired portions thereof) in a polymer layer.

In support of the teachings herein, various analysis components may be used, including a digital and/or an analog system. The analysis assembly and a computer connected to the analysis assembly may have components such as a processor, storage media, memory, input, output, communications link, user interfaces, software programs, signal processors (digital or analog) and other such components (such as resistors, capacitors, inductors and others) to provide for operation and analyses of the apparatus and methods disclosed herein in any of several manners well appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing for aspects of the teachings herein. For example, a power supply (e.g., at least one of a generator, a remote supply and a battery), cooling unit, heating unit, motive force (such as a translational force, propulsion force or a rotational force), magnet, electromagnet, sensor, electrode, transmitter, receiver, transceiver, antenna, controller, optical unit, electrical unit or electromechanical unit may be included in support of the various aspects discussed herein or in support of other functions beyond this disclosure.

It will be recognized that the various components or technologies may provide certain necessary or beneficial functionality or features. Accordingly, these functions and features as may be needed in support of the appended claims and variations thereof are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the appended claims.

1. A downhole sensor to detect characteristics in a borehole, the downhole sensor comprising:
at least one sensing unit to sense at least one characteristic in the borehole; and
at least one metallic layer covering at least a portion of the at least one sensing unit exposed to an interior of the borehole.

2. The downhole sensor of claim 1, wherein the at least one metallic layer forms a hermetic seal around the at least one sensing unit.

3. The downhole sensor of claim 1, wherein the at least one metallic layer encapsulates the at least one sensing unit.

4. The downhole sensor of claim 3, further comprising a polymer layer between the at least one metallic layer and the at least one sensing unit.

5. The downhole sensor of claim 1, wherein the downhole sensor is one of a pressure sensor, a drag sensor, a torque sensor, a radiation sensor, an acoustic sensor, an ultrasonic sensor, an induction sensor, or other formation evaluation sensor.

6. The downhole sensor of claim 1, wherein the at least one metallic layer comprises at least one of aluminum, copper, gold, iridium, platinum, and titanium or combination thereof in an alloyed metal.

7. The downhole sensor of claim 1, wherein an outer surface of the at least one sensing unit is covered with a polymer, and
the at least one metallic layer covers the polymer.

8. A downhole analysis assembly, comprising:
an analysis assembly casing to be inserted downhole in a borehole; and
at least one sensing unit connected to the analysis assembly casing to sense at least one characteristic in the borehole, at least a portion of the at least one sensing unit being exposed to an interior of the borehole, the portion of the at least one sensing unit exposed to the interior of the borehole being coated with a metallic layer.

9. The downhole analysis assembly of claim 8, wherein the entire at least one sensing unit is encapsulated in the metallic layer.

10. The downhole analysis assembly of claim 8, further comprising a processing unit to receive sensing data from the sensing unit and to transmit the sensing data out of the borehole.

11. The downhole analysis assembly of claim 8, wherein the metallic layer hermetically seals the at least one sensing unit from the interior of the borehole.

12. A method of applying a metallic layer to a downhole sensor, the method comprising:
coating at least a portion of a downhole sensor to sense characteristics from an interior of a borehole with a metallic layer to form a hermetic seal between the downhole sensor and the interior of the borehole.

13. The method of claim 12, wherein the metallic layer includes at least one of aluminum, copper, gold, iridium, platinum, and titanium or combination thereof as an alloyed metal.

14. The method of claim 12, wherein coating the at least a portion of the downhole sensor includes encapsulating the entire downhole sensor in the metallic layer.

15. The method of claim 12, wherein coating the at least a portion of the downhole sensor includes coating a portion of the downhole sensor to be exposed to the interior of the borehole with the metallic layer.

16. The method of claim 12, wherein the coating is performed by electroless plating.

17. The method of claim 12, wherein the coating is performed by vacuum deposition.

18. The method of claim 12, wherein the coating is performed by sputtering.

19. The method of claim 12 wherein an outer surface of the downhole sensor is covered with a polymer, and coating the at least a portion of the downhole sensor includes coating the polymer with the metallic layer.
